(19) United States
(12) Patent Application Publication
(10) Pub. No.: US 2011/0142067 A1
(43) Pub. Date: Jun. 16, 2011

(54) DYNAMIC LINK CREDIT SHARING IN QPI

(76) Inventors: Timothy J. JEHL, Gilbert, AZ (US); Pradeepsunder Ganesh, Chandler, AZ (US); Aimee Wood, Tigard, OR (US); Robert Safranek, Portland, OR (US); John A. Miller, Portland, OR (US); Selim Bilgin, Hillsboro, OR (US); Osama Neiroukh, Jerusalem (IL)

(21) Appl. No.: 12/639,556

(22) Filed: Dec. 16, 2009

(51) Int. Cl. H04J 3/02

(52) U.S. Cl. 370/462

(57) ABSTRACT

A method and system for dynamic credit sharing in a quick path interconnect link. The method including dividing incoming credit into a first credit pool and a second credit pool; and allocating the first credit pool for a first data traffic queue and allocating the second credit pool for a second data traffic queue in a manner so as to preferentially transmit the first data traffic queue or the second data traffic queue through a link.

### BACKGROUND OF THE INVENTION

1. Field of the Invention

The present invention pertains to data management, and in particular to a dynamic link credit sharing method and system in quick path interconnect.

2. Discussion of Related Art

QuickPath Interconnect (QPI) protocol is a credit based protocol. In its simplest form, on a single-processor motherboard architecture, a single QPI is used to connect the processor to the Input-Output (IO) hub. The IO hub can in turn be connected to peripheral devices such as graphics cards, etc. The IO hub can further communicate with an Input-Output Controller Hub (e.g., Intel's Southbridge ICH10) for connecting and controlling peripheral devices.

For example, QPI can be used to connect an Intel Core i7 processor (a 64-bit x86-64 processor) to an Intel X58 IO hub. In more complex instances of the architecture, separate QPI link pairs connect one or more processors and one or more IO hubs (or routing hubs) in a network on the motherboard, allowing all of the components to access other components via the network. As with HyperTransport (a bidirectional serial/parallel high-bandwidth point-to-point link), the QuickPath Interconnect (QPI) architecture allows for memory controller integration, and enables a non-uniform memory architecture (NUMA).

### BRIEF SUMMARY OF THE INVENTION

An aspect of the present invention is to provide a method including dividing incoming credit into a first credit pool and a second credit pool; and allocating the first credit pool for a first data traffic queue and allocating the second credit pool for a second data traffic queue in a manner so as to preferentially transmit the first data traffic queue or the second data traffic queue through a link.

Another aspect of the present invention is to provide a system including a link having a transmitter side and a receiver side; and a controlled bias register configured to divide incoming credit into a first credit pool and a second credit pool. The first credit pool is allocated for a first data traffic queue and the second credit pool is allocated for a second data traffic queue such that the transmitter side preferentially transmits the first data traffic queue or the second data traffic queue through the link.

Although the various steps of the method are described in the above paragraphs as occurring in a certain order, the present application is not bound by the order in which the various steps occur. In fact, in alternative embodiments, the various steps can be executed in an order different from the order described above or otherwise herein.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

In the accompanying drawings:

FIG. 1 is a schematic diagram showing a transmitter side and a receiver side of a link, according to an embodiment of the present invention;

FIG. 2 is a schematic diagram depicting the local and route-through traffic queues to and from a device, according to an embodiment of the present invention; and

FIG. 3 is a schematic diagram depicting an implementation of a credit sharing mechanism between local data traffic queue and route-through data traffic queue at the transmitter side of the link shown in FIG. 1, according to an embodiment of the present invention.

### DETAILED DESCRIPTION OF EMBODIMENTS OF THE INVENTION

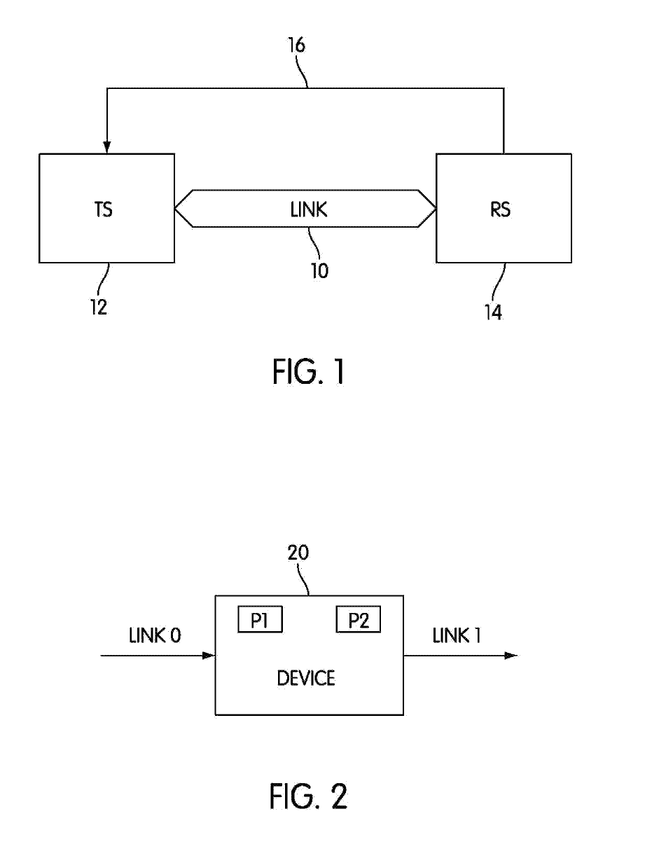

FIG. 1 is a schematic diagram showing a transmitter side and a receiver side of a link, according to an embodiment of the present invention. The link 10 has a transmitter side (TS) 12 on one side and a receiver side (RS) 14 on the opposite side. For example, the link 10 can use the QuickPath interconnect Protocol to connect between the transmitter side 12 (e.g., an Intel Core i7 processor) and a receiver side 14 (e.g., an Intel X58 IO hub or another Intel Core i7 processor). The transmitter side (TS) 12 of link 10 must “know” in advance that adequate space is available on the receiver side (RS) 14 of the link 10 before the transmitter side 12 can start a given transaction with the receiver side 14. To achieve a seamless and substantially error free transmission between the transmission side 12 and the receiver side 14 of the link 10, the receiver side 14 of the link 10 “informs” the transmission side 12 of availability of “credit.” In other words, the receiver side 14 advertises credits to the transmitter side 12. In order to inform the transmitter side 12 of the availability of credit on the receiver side 14, in one embodiment, a communication channel or link 16, independent from link 10, is established between the receiver side 14 and the transmitter side 12 of the link 10. The receiver side 14 can then communicate with the transmitter side 12 via communication path or link 16 to inform the transmitter side 12 of availability of credit on the receiver side 14. In this way, the transmitter side 12 would “know” how much room or credit in terms of data size is available on one or more channels on the receiver side 14. The term data size is used herein to mean in general either flits (80 bit data portions) or data packets for individual known transmission packet types. Although, in this embodiment, the link 16 is depicted as being independent from link 10, as it can be appreciated the link 16 can be a sideband of the link 10 to inform the transmitter side 12 of availability of credit at the receiver side 14. It is noted that the components 12 and 14 are respectively referred to as transmitter side 12 and receiver side 14, when referring to transmitting data through link 10 from component 12 to component 14. As it can be appreciated, the components 12 and 14 can act, respectively, as “receiver side” 12 and “transmitter side” 14 when data is sent from the component 14 to component 12, for example, when sending information through link 16.

For example, in a device, such as for example a server part optimized for embedded systems, the transmitter side 12 within the device services two request queues, one of which is a local data traffic queue and the other is a route-through data traffic queue. Local data traffic is data traffic that is generated by a processor or processors within the device, such as for example data generated by a processor or processors within the device. Route-through data traffic is data traffic that is generated externally to the device, and is simply passing through the device, as explained further in detail in the following paragraphs.

FIG. 2 is a schematic diagram depicting the local and through traffic queues to and from a device 20, according to an embodiment of the present invention. As depicted in FIG. 2, device 20 receives data in bound on link 0 and transmits data outbound on link 1. Therefore, from the point of view of outbound link 1 from the device 20, local data traffic is generated within the device 20 by the one or more processors on the device 20, for example processors P1 and P2 (or possibly returns of memory within the device 20 requested through link 1). Route-through data traffic is not generated within the device 20, but corresponds to incoming data packets through link 0. The route-through data traffic is not destined for the device 20, but instead is data traffic incoming through link 0 being routed through to go out link 1.

Due to architectural limitations, the local data traffic queue originating from the device 20 and route-through data traffic queue routed through the device 20 must be informed that a data transaction between the device 20 and other devices (e.g., peripheral devices or an IO hub) can be completed prior to pulling the data transaction from the queue. In other words, the local data traffic queue originating from the transmitter side 12 within the device 20 and route-through data traffic queue routed through the transmitter side 12 within the device 20 should be informed that a data transaction between the transmitter side 12 within the device 20 and the receiver side 14 within an IO hub, for example, can be completed prior to pulling the transaction from the local data traffic queue or the route-through data traffic queue. Prior to sending “data”, the transmitter side 12 should have credit that guarantee that there is space at the receiver side 14 for receiving the data (e.g., storage space).

Credit consumption is managed at the transmitter side 12. Therefore, credits sent by the receiver side 14 of the link 10 (corresponding to link 1 in FIG. 2) to the transmitter side 12 of the link 10 (the transmitter side 12 residing within the device 20) via link 16 should be divided appropriately by the transmitter side 12 into two separate credit pools (a first credit pool and a second credit pool). For example, the first credit pool can be allocated to the local data traffic and the second credit pool can be allocated to the route-through traffic.

By judiciously dividing, at the transmitter side 12, the credit available at the receiver side 14 and advertised by the receiver side 14 to the transmitter side 12, into a first credit pool allocated to the local data traffic and a second credit pool allocated to the route-through traffic, for example, performance of data transmission through link 10 (corresponding to link 1) can be improved.

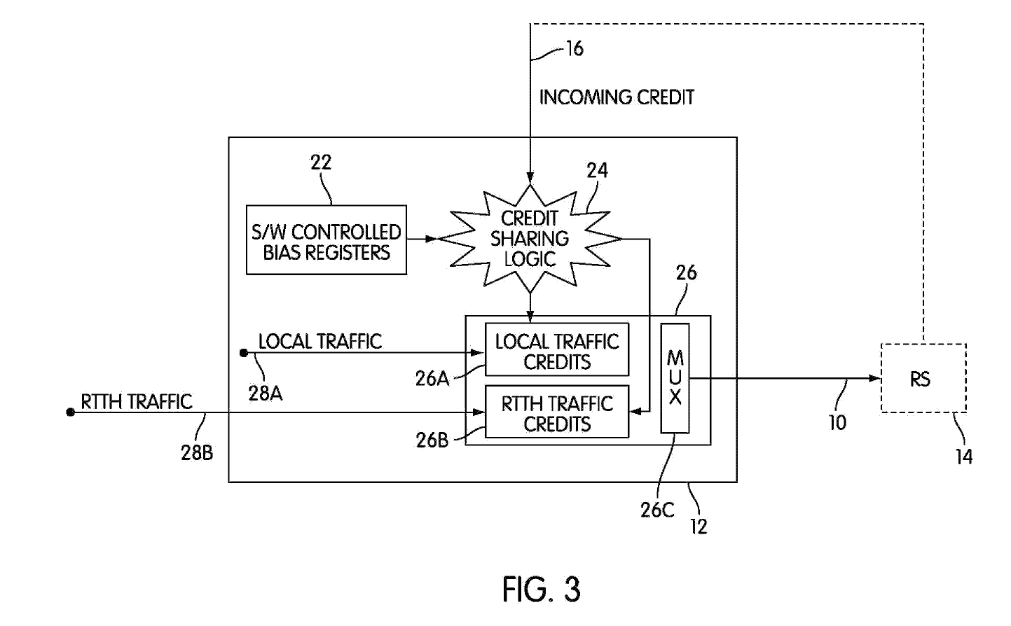

FIG. 3 is a schematic diagram depicting an implementation of a credit sharing or division mechanism between the local data traffic queue and the route-through data traffic queue at the transmitter side 12 of link 10, according to an embodiment of the present invention. As shown in FIG. 3, the transmitter side 12 of link 10 (corresponding to link 1 in FIG. 2) includes software (S/W) controlled bias register or registers 22, credit sharing or division logic 24 and a data traffic management engine 26. The data traffic management engine 26 includes local data traffic credit repository 26A, route-through (RTTH) data traffic credit repository 26B, and a data multiplexer (MUX) 26C. Local data traffic queue 28A originating from the transmitter side 12 within the device 20 and route-through (RTTH) data traffic queue 28B routed through the transmitter side 12 within the device 20 are directed towards data traffic management engine 26.

Specifically, local data traffic queue 28A is routed via local traffic credit repository 26A and route-through (RTTH) data traffic queue 28B is routed via route-through (RTTH) traffic credit repository 26B. The respective amount of local data traffic 28A and amount of RTTH data traffic 28B that pass through the data traffic management engine 26 is determined by the respective local traffic credit repository 26A and RTTH traffic credit repository 26B. These repositories 26A and 26B, respectively, store the local data traffic and RTTH traffic credits which are communicated by the receiver side 14 (shown in FIG. 1) of the link 10 to the transmitter side 12. The data multiplexer 26C multiplexes the local data traffic 28A and RTTH data traffic and the resulting multiplexed data is transmitted through outbound link 10.

The local traffic credit repository 26A and the RTTH traffic repository 26B are controlled by credit sharing or division logic 24. The credit sharing or division logic 24 receives inputs from bias register(s) 22 and from the receiver side 14 which communicates the available credit (as incoming credit) to the transmitter side 12 via communication path or link 16. The S/W controlled bias register(s) 22 determine how much credit is available in terms of local traffic credits for the local data traffic queue 28A and RTTH traffic credits for the RTTH data traffic queue 28B.

The bias register(s) 22 inputs bias values to the credit sharing or division logic 24 so that the credit sharing or division logic 24 divides or controls the available credit incoming through link 16 appropriately into an amount or pool of local traffic credit stored in local traffic credit repository 26A and into an amount or pool of RTTH traffic credit stored in RTTH traffic credit repository 26B. By dividing the incoming credit into a local traffic credit and a RTTH traffic credit and allocating more credit to the local data traffic queue 28A or to the RTTH data traffic queue, the local data traffic queue 28A or the RTTH data traffic queue 28B is preferentially transmitted or is given preferential bandwidth through link 10. For instance, if the RTTH data traffic queue is biased with 16 credits, and both queues (i.e., the local data traffic queue and the RTTH data traffic queue) are initially empty, the system interprets as if the route through (RTTH) data traffic queue already possesses 16 credits, and the system would not “think” (i.e., conclude) that the two data traffic queues are “equal” until the local data traffic queue reaches 16 credits as well. As a result, the system can transmit preferentially the local data traffic queue 28A. Although, the incoming credit is described herein as being divided into two credit pools, it must be appreciated that the available credit or incoming credit can be divided into two, three or more credit pools. Each of the two, three or more credit pools can be allocated to a specific queue and the queue that is allocated more credit is preferentially transmitted.

If no bias value is applied in the S/W controlled register(s) 22, the system attempts to fill each queue (i.e., the local traffic data queue and the RTTH data traffic queue) evenly or equally. Thus, if any queue (i.e., any one of the local data traffic queue or the RTTH data traffic queue) begins using credits, the used credits are returned to the same queue to attempt once again to match the levels between the two queues.

If a bias value is applied in the S/W controlled register(s) 22, the system instead attempts to maintain a difference in levels of the two queues equal to the bias. Hence, in an environment with few credits, one queue receives the majority of credits. As a result, the performance of the queue that receives the majority of credits is favored. The overall system performance by providing an asymmetric or unbalanced credits configuration when using the bias can be improved.

When the transmitter side 12 transmits packets to the receiver side 14 through the link 10, the transmitter side 12 consumes credits. For example, when the transmitter side 12 has initially 10 credits and the transmitter side uses 3 credits to transmit data packets to the receiver side 14, the remaining useable credit for the transmitter side 12 to use to transmit data packets is 7 credits. As the transmitted packets get processed on the receiver side 14, the receiver side 14 frees up space to accept new packets. The availability of freed up space is communicated by the receiver side 14 to the transmitter side 12 via link 16.

In an embodiment, QPI protocol uses two different types of credits. These two types of credits are a direct indication of available buffers on the receiver side 12. The credits used by the QPI protocol can guarantee that the receiver side 12 has buffers to store or buffer the packet transmitted by the transmitter side 14. One type of credits is the VN0 credits and another type is the VNA credits. The VN0 credits are transaction based and are allocated to individual packet classes. There are six such classes. In an embodiment, there are two credits for each of the six classes, with one being allocated for the route through traffic, and one for the local traffic. The VNA credits (miscellaneous credits) are allocated to any virtual channel but depend on the size of the transaction's packet. For VN0 credits, the RTTH data traffic queue will only support one credit for any virtual channel, if that channel has a credit already allocated to it. Although, the QPI protocol is described herein as using two types of credits VN0 and VNA, it must be appreciated that, in other embodiments, the QPI protocol can use three types of credits VN0, VN1 and VNA.

Management of VNA credit consumption is implemented as described in the above paragraphs. For VNA credits, the transmitter side 12 monitors the size of each queue and as credits come back from the receiver side 14 in quanta of 2/8/16 bit (equivalent to approximately 80 bit flit), the credits are returned to the queue which has the lesser number of credits. In an embodiment, the basic unit of data is the 80 bit flit. This is generally an encoded 64 bits. The variety of packet types available will typically use from 1 to 11 of these flits. For example, in an embodiment, inbound storage buffer on the device 20 will hold up to 128 of these flits. VNA credits are not packet specific, and are therefore encoded in flits. If there is a 3 flit packet to send, there must be at least 3 VNA credits available to do so, etc. VN0 credits, on the other hand, are based solely on packets for particular message classes. These packets can be of varying size, but the VN0 is allocated assuming the largest possible packet size for this message class. Therefore, a 3-flit packet would only take up one VN0 credit. VNA credits are far more versatile. As an example, in a high activity system, VNA credits could be reduced to where they are being consumed so fast that a message class carrying an 11-flit message would never have enough VNA credits to transmit. This is because message classes don't get priority simply because they've been sitting for a longer period of time. However, because VN0 are message class specific, when a VN0 credit is available for that message class, the size of the message is irrelevant and the packet can be transmitted.

In the case of VN0 packets, because VN0 packets are allocated to each message class, they can prevent lockups. For example, if a local data traffic queue 28A is empty, and the local data traffic queue 28A has available credit (any available credit different from 0), the returning credit from the receiver side 14 is returned to RTTH traffic credit repository 26B to be used by the route through data traffic queue 28B. By doing so, the possibility for a dead-lock condition can be prevented. As it can be appreciated, a deadlock condition is a condition in which, for example, in order to do A, B must be done first, but in order to do B, A must happen first. As a result, nothing gets done. By returning the available incoming credit from the receiver side 14 to the RTTH traffic credit repository 26B instead of the local traffic credit repository 26A, the returned credits can be used by the RTTH data traffic queue 28B. If the available credits were to be returned to the local traffic credit repository 26A and there is no local traffic, the returned credit will not be used because there is no local traffic. As a result, the RTTH traffic queue 28B which may need credit will be “starved” and the RTTH traffic flow will be blocked, creating a deadlock situation.

In the case of VN0 credits, if there are no credits available for either queue, i.e., no credit in either the local traffic credit register 16A for use by the local data traffic queue 28A and no credit in the RTTH traffic credit register 26B for use by the RTTH data traffic queue 28B, the credits allocated are returned via link 16, preventing possible live-lock scenarios. As it can be appreciated, a live lock scenario is a scenario in which a particular channel or queue gets starved for lack of resource. For instance, if one assumes that both credits (i.e., the local traffic credit and the RTTH traffic credit) get used, and one of the credits returns from the receiver side 14 via link 16 as incoming credit, both queues (local data traffic queue 28A and RTTH data traffic queue 28B) have something to transmit. Hence, arbitrarily, the credit can be assigned to the local traffic credit register again 26A to be used by local data traffic queue 28A. The local data traffic queue 28A uses the credit, and when this credit returns via incoming link 16, the credit may be arbitrarily assigned to the local traffic credit register 26A again. Hence, the local data traffic queue 28A may arbitrarily use the credit again. If this is repeated numerous times, the route through data traffic queue 28B may not be able to transmit data and may remain inactive for a long time. This situation is a live-lock where the RTTH data traffic queue 28A is starved. However, it can be assumed that at some point, there will be an instance were both credits (instead of only one credit) get returned, and eventually the RTTH data traffic queue or path 28B can transmit again.

As can be appreciated from the above paragraphs, the S/W controlled bias register(s) can optimally control or program the sharing of the VNA credits. For example, in one embodiment, software can be implemented to program the bias register based on whether the application running on the embedded processor is local traffic intensive or route-through traffic intensive. Hence, the above described system and method can improve performance with a route through mechanism for a given application to allow the biasing of available resources in a way that is optimal for that application. As a result, available QPI bandwidth is used judiciously and not wasted by dividing the bandwidth (i.e., credit) and allocating more bandwidth (i.e., credit) to the queue that needs more resources for a given application.

For example, a system using credit division or sharing logic on VNA may display a relatively large QPI bandwidth. In a dual-processor-route-through (DPRTTH) enabled system, for example, a heavy local traffic application can be implemented to access the memory (RAM) of the second processor across the link between the first processor and the second processor, with transmitters and receivers on both sides of the link. For example, if a relatively high QPI bandwidth is detected, this may suggest that the local data traffic queue is using almost all the advertised VNA credits. A route through heavy traffic application can be run to access memory across the link. If the QPI bandwidth being used is high enough this may suggest that the route-through traffic is using almost all the communicated or advertised VNA credits.

In one embodiment, in a QPI link using the credit sharing or division logic described herein, approximately all VNA credits are used. Hence, there are less VNA credits available than would be necessary to allow maximum theoretical bandwidth from both local and route through traffic from the transmitter side. This means that, on occasion, traffic is held up on the transmitter side for lack of credits to send across the link (e.g., waiting for “returning credit”). This could happen to either or both paths. By tuning the bias to the application, it is possible, for instance, to prevent one path from ever getting backed up due to credit starvation, while making this a more likely possibility on the other path. For instance, if it is known in advance that there will be plenty of local traffic and relatively little route through traffic, it can be possible to bias against route through traffic to ensure that local traffic is provide with as much bandwidth as desired.

Although the various steps of the method of providing or printing postage indicia are described in the above paragraphs as occurring in a certain order, the present application is not bound by the order in which the various steps occur. In fact, in alternative embodiments, the various steps can be executed in an order different from the order described above.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

Furthermore, since numerous modifications and changes will readily occur to those of skill in the art, it is not desired to limit the invention to the exact construction and operation described herein. Accordingly, all suitable modifications and equivalents should be considered as falling within the spirit and scope of the invention.

What is claimed:

1. A method comprising:
dividing incoming credit into a first credit pool and a second credit pool; and
allocating the first credit pool for a first data traffic queue and allocating the second credit pool for a second data traffic queue in a manner so as to preferentially transmit the first data traffic queue or the second data traffic queue through a link.

2. The method according to claim 1, further comprising:
receiving the first data traffic queue and the second data traffic queue, the first data traffic queue originating from a transmitter side within a device and the second data traffic queue is route-through data passing through the transmitter side within the device.

3. The method according to claim 2, wherein receiving the second data traffic queue comprises receiving the second data traffic queue from another device different from the device including the transmitter side of the link.

4. The method according to claim 2, further comprising:
receiving incoming credit from a receiver side, the incoming credit informing the transmitter side of data space available at the receiver side.

5. The method according to claim 4, wherein receiving incoming credit from the receiver side comprises receiving the incoming credit through another link different from the above mentioned link.

6. The method according to claim 1, wherein dividing the incoming credit into the first credit pool and the second credit pool comprises dividing unequally the incoming credit into the first credit pool and into the second credit pool.

7. The method according to claim 1, further comprising storing the first credit pool in a first credit repository and storing the second credit pool in a second credit repository.

8. The method according to claim 1, further comprising biasing the second credit pool relative to the first credit pool so as to preferentially transmit the first data traffic queue.

9. The method according to claim 1, wherein the incoming credit comprises VN0 credit and VNA credits.

10. The method according to claim 1, wherein dividing the incoming credit into the first credit pool and the second credit pool comprises dividing the VNA credits in the incoming credit.

11. A system comprising:
a link having a transmitter side and a receiver side; and
a controlled bias register configured to divide incoming credit into a first credit pool and a second credit pool,
wherein the first credit pool is allocated for a first data traffic queue and the second credit pool is allocated for a second data traffic queue such that the transmitter side preferentially transmits the first data traffic queue or the second data traffic queue through the link.

12. The system according to claim 11, wherein the transmitter side of the link is configured to receive the first data traffic queue and the second data traffic queue, the first data traffic queue originating from the transmitter side within a device and the second data traffic queue is route-through data passing through the transmitter side within the device.

13. The system according to claim 11, wherein the transmitter side is further configured to receive the incoming credit through a credit link from the receiver side of the link, the incoming credit informing the transmitter side of data space available at the receiver side.

14. The system according to claim 13, wherein the credit link is distinct from the link.

15. The system according to claim 11, wherein the controlled bias register is configured to divide unequally the incoming credit into the first credit pool and into the second credit pool.

16. The system according to claim 11, further comprising a first credit repository and a second credit repository, the first credit repository configured to store the first credit pool and the second credit repository configured to store the second credit pool.

17. The system according to claim 11, further comprising a credit sharing logic controlled by the bias register.

18. The system according to claim 11, wherein the incoming credit comprises VN0 credit and VNA credit.

19. The system according to claim 18, wherein the controlled bias register is configured to divide incoming credit into the first credit pool and the second credit pool comprises dividing the VNA credit in the incoming credit.
